(19) United States
(12) Patent Application Publication
(10) Pub. No.: US 2016/0349597 A1
(43) Pub. Date: Dec. 1, 2016

(54) SUPPORT DEVICE

(71) Applicant: HON HAI PRECISION INDUSTRY CO., LTD., New Taipei (TW)

(72) Inventors: CHEN-CHING CHU, New Taipei (TW); YU-NING WANG, New Taipei (TW); CHENG-KUO LEE, New Taipei (TW)

(21) Appl. No.: 14/837,944

(22) Filed: Aug. 27, 2015

(30) Foreign Application Priority Data
May 29, 2015 (CN) 201510286085.9

(51) Int. Cl. G03B 15/02; G03B 17/56

(52) U.S. Cl. CPC G03B 15/02; G03B 17/561

(57) ABSTRACT

A support device includes a main body and two supporting arms. The main body is configured to support an electronic device. The main body defines a slot. The slot is configured to allow lights to pass through when a camera of the electronic device captures an image. Two supporting arms are coupled to the main body. The two supporting arms are configured to form a first predetermined angle with the main body and are positioned at the first predetermined angle. The two supporting arms are configured to contact a surface to form three supporting points when the two supporting arms are arranged on the surface, solely supporting the main body and the electronic device above the surface. The three supporting points on the surface is distributed in a shape of a surface.

### CROSS-REFERENCE TO RELATED APPLICATIONS

This application claims priority to Chinese Patent Application No. 201510286085.9 filed on May 29, 2015, the contents of which are incorporated by reference herein.

### FIELD

The subject matter herein generally relates to support devices, and particularly, to a support device capable of assisting an electronic device to capture images.

### BACKGROUND

Cameras are commonly employed in electronic devices, such as mobile phones, tablet personal computers, for capturing images. Cameras can be mounted on a front surface or a rear surface. The camera can also be paired with a flash for low light situations.

### BRIEF DESCRIPTION OF THE DRAWINGS

Implementations of the present technology will now be described, by way of example only, with reference to the attached figures, wherein:

FIG. 1 is an isometric view showing an embodiment of a support device and an electronic device.

FIG. 2 illustrates a bottom plan view of the support device of FIG. 1 in a folded state receiving the electronic device.

FIG. 3 illustrates a bottom plan view of the support device of FIG. 1 in an unfolded state.

FIG. 4 illustrates a left side view of the support device of FIG. 1 in an unfolded state.

FIG. 5 is an isometric view showing an embodiment of a supporting arm of the support device of FIG. 1, being a first supporting arm.

FIG. 6 is an isometric view showing an embodiment of the supporting arm of the support device of FIG. 1, being a second supporting arm.

FIG. 7 is a cross-sectional view taken along line VII-VII of FIG. 5.

FIG. 8 is an enlarged, cross-sectional view of circled portion VIII of FIG. 7.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

Embodiments of the present disclosure will be described with reference to the accompanying drawings.

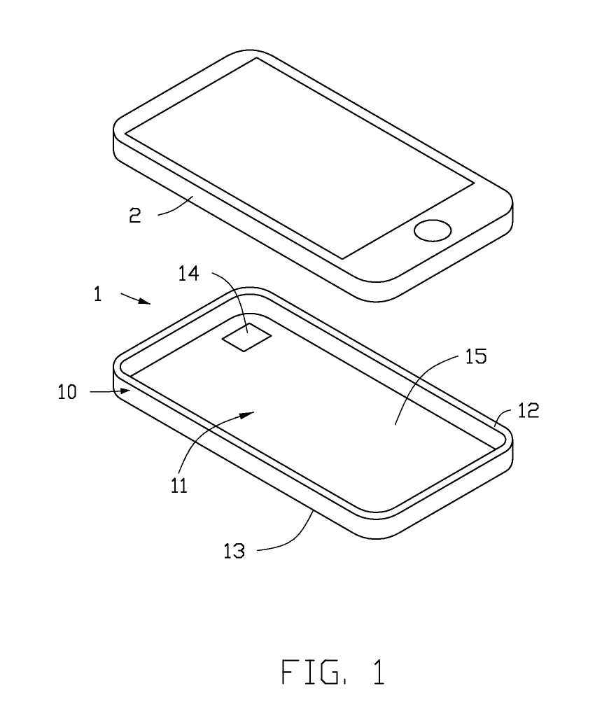

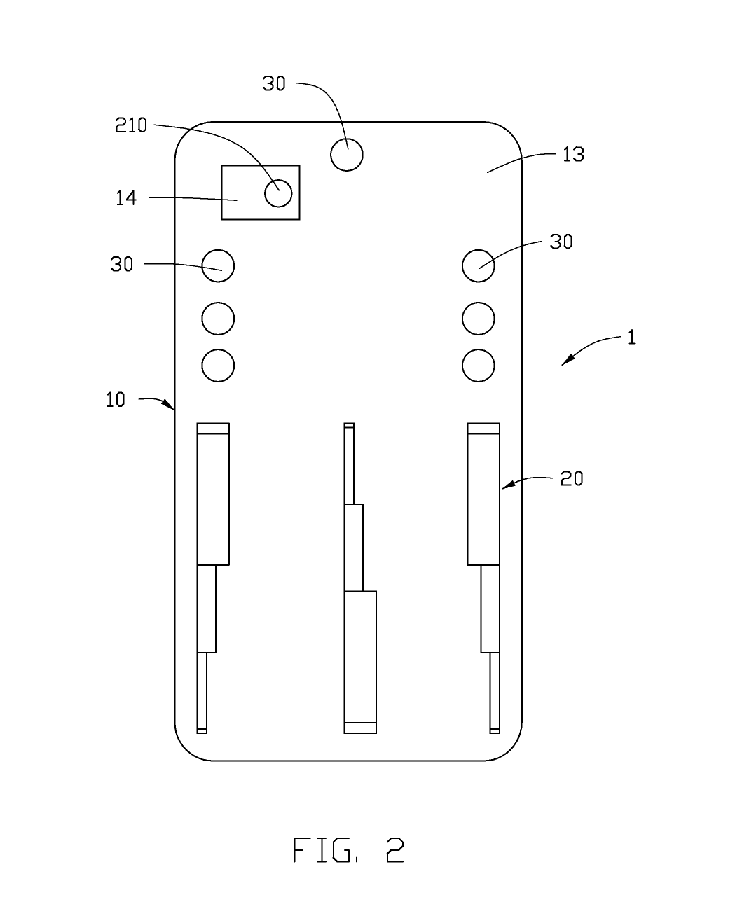

FIGS. 1-2 illustrate a view of an embodiment of a support device 1 and an electronic device 2. The support device 1 can include a main body 10, at least two supporting arms 20, and a number of lamps 30. The main body 10 can be configured to position and support the electronic device 2. In at least one embodiment, the electronic device 2 can include a camera 210. The camera 210 can be configured to capture an image.

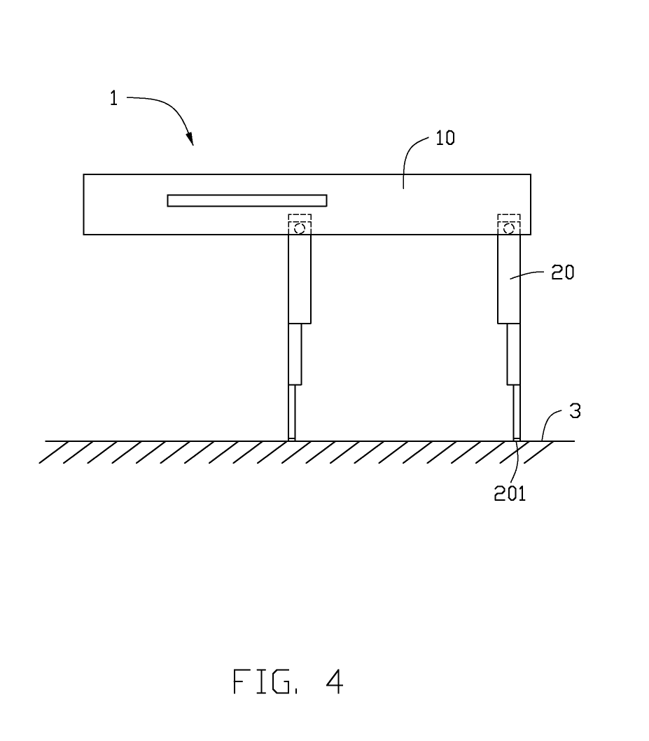

The at least two supporting arms 20 can be coupled to the main body 10. Each supporting arm 20 can form a first predetermined angle with the main body 10 and can be positioned at the first predetermined angle. In at least one embodiment, the first predetermined angle can be 0 degrees, 45 degrees, 90 degrees, or any other angle. In at least one embodiment, the angles formed between the supporting arms 20 and the main body 10 can be the same or different, for example, the angle formed between one supporting arm and the main body 10 can be 30 degrees and the angle formed between the other supporting arms and the main body 10 can be 0 degrees. The at least two supporting arms 20 can contact a surface 3 (see FIG. 4) to form at least three supporting points 201 (see FIG. 4) when the at least two supporting arms 20 are arranged on the surface 3. The at least three supporting points 201 on the surface 3 can be distributed in a shape of a surface. Thus, the at least two supporting arms 20 can solely support the main body 10 and the electronic device 2 above the surface 3. The lamps 30 can be fixed to the main body 10. The lamps 30 can be configured to emit light for photography, causing the image captured by the camera 210 of the electronic device 2 to be clear.

In at least one embodiment, the main body 10 can define a receiving groove 11. The receiving groove 11 can be configured to receive the electronic device 2. In at least one embodiment, the main body 10 can include a first surface 12 and a second surface 13 opposite to the first surface 12. In at least one embodiment, the first surface 12 can be an upper surface, and the second surface 13 can be a lower surface. The receiving groove 11 can extend from the first surface 12 to the second surface 13. The receiving groove 11 can be replaced by any other suitable device, such as an elastic band, to fix the electronic device 2 to the first surface 12 of the main body 10. In at least one embodiment, the main body 10 can further define a slot 14. The slot 14 can be configured to allow light to pass through when the camera 210 captures the image. In at least one embodiment, the slot 14 can be defined at the bottom 15 of the receiving groove 11. The main body 10 can further define other openings to allow the buttons of the electronic device 2 to pass through.

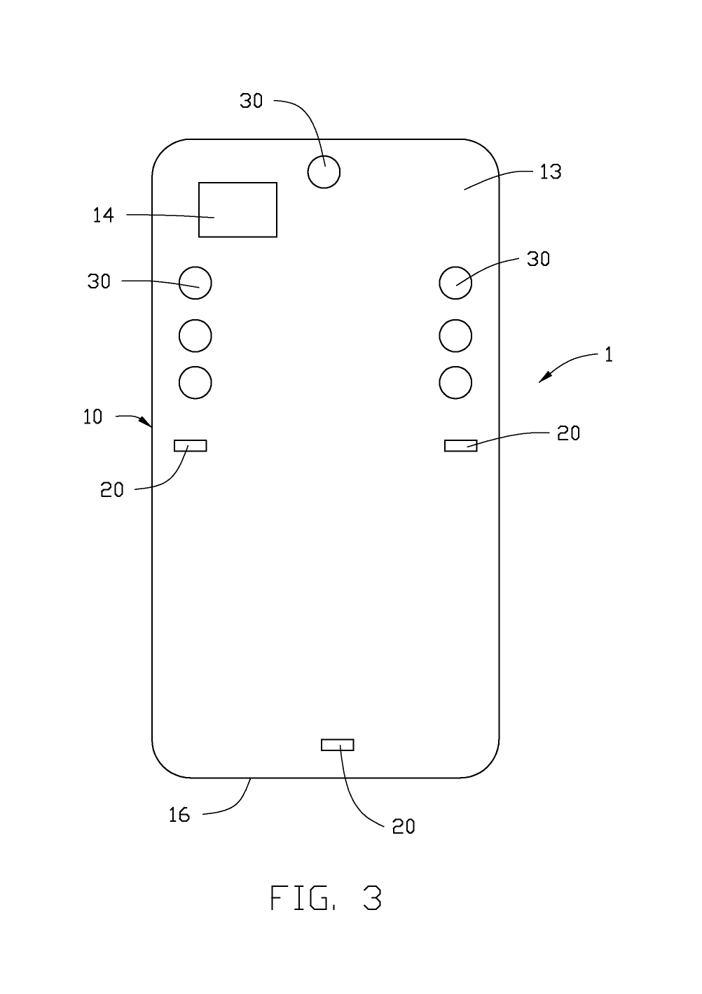

FIGS. 3-4 illustrate a view of an embodiment of the support device 1. In at least one embodiment, three supporting arms 20 can be taken as an example. The number of the supporting arms 20 can be any other number which is greater than one, such as two, four, five, or the like. Each supporting arm 20 can be coupled to the main body 10. In at least one embodiment, each supporting arm 20 can be coupled to the second surface 13 of the main body 10. In at least one embodiment, each supporting arm 20 can be rotatably coupled to the main body 10. For example, each supporting arm 20 can be rotatably coupled to the main body 10 via a hinge. In other embodiments, each supporting arm 20 can be detachably coupled to the main body 10, fixed to the main body 10, or coupled to the main body 10 in any other suitable ways. Each supporting arm 20 can form the first predetermined angle with the main body 10 and be positioned at the first predetermined angle. In at least one embodiment, the supporting arms 20 can be same in length. In other embodiments, the supporting arms 20 can be different in length, for example, the lengths of two of three supporting arms 20 can be 15 centimeters, but the length of the other supporting arms 20 can be 12 centimeters. In at least one embodiment, the supporting points 201 on the surface 3 can be distributed in a shape of a triangle. In at least one embodiment, the triangle can be an isosceles triangle, a right triangle, or any other type triangle.

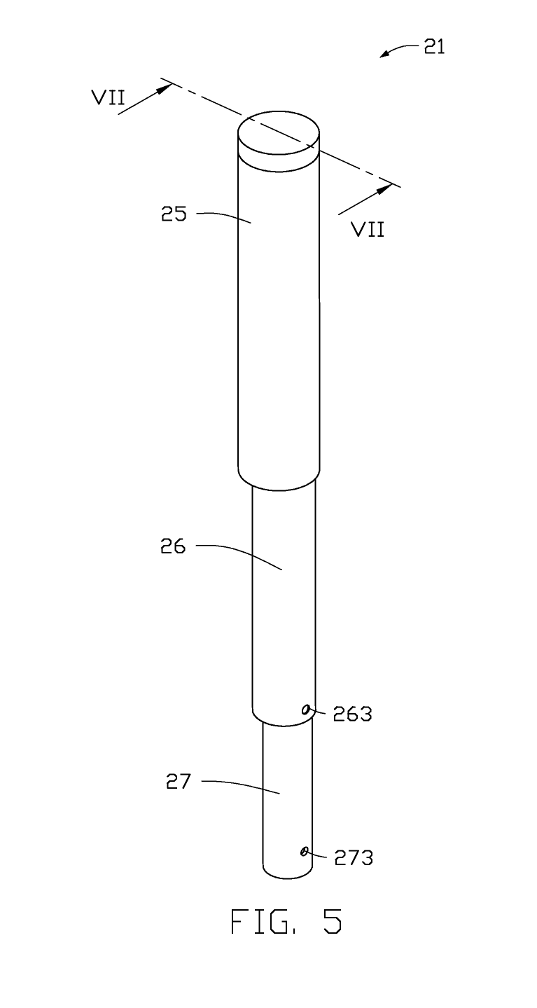

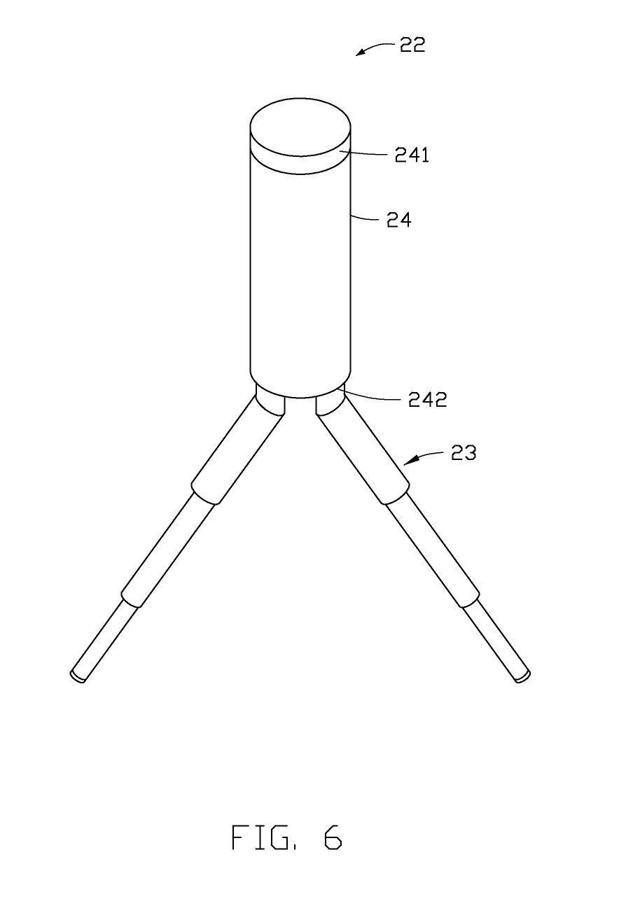

In at least one embodiment, the supporting arms 20 can be a plurality of first supporting arms 21, a number of second supporting arms 22, or a combination of at least one first supporting arm 21 and at least one second supporting arm 22. Each first supporting arm 21 can include a supporting rod 23 (see FIG. 5). Each second supporting arm 22 can include a connecting rod 24 (see FIG. 6) and at least two supporting rods 23. Each connecting rod 24 can include a first end 241 and a second end 242 opposite to the first end 241. The first end 241 of each connecting rod 24 can be coupled to the main body 10, and the second end 242 of each connecting rod 24 can be coupled to a corresponding at least two supporting rods 23. Each supporting rod 23 can be rotatably connected to the connecting rod 24. Each supporting rod 23 can be rotatably connected to the connecting rod 24 via the hinge. In other embodiments, each supporting rod 23 can be detachably connected to the corresponding connecting rod 24, fixed to the corresponding connecting rod 24, or coupled to the corresponding connecting rod 24 in any other suitable ways. Thus, each supporting rod 23 can form a second predetermined angle with the corresponding connecting rod 24 and be positioned at the second predetermined angle. The second predetermined angle can be 0 degrees, 45 degrees, 90 degrees, or any other angle. The angles formed between the supporting rods 23 and the connecting rod 24 can be same or different. The second predetermined angle can be the same as the first predetermined angle, or can be different from the first predetermined angle.

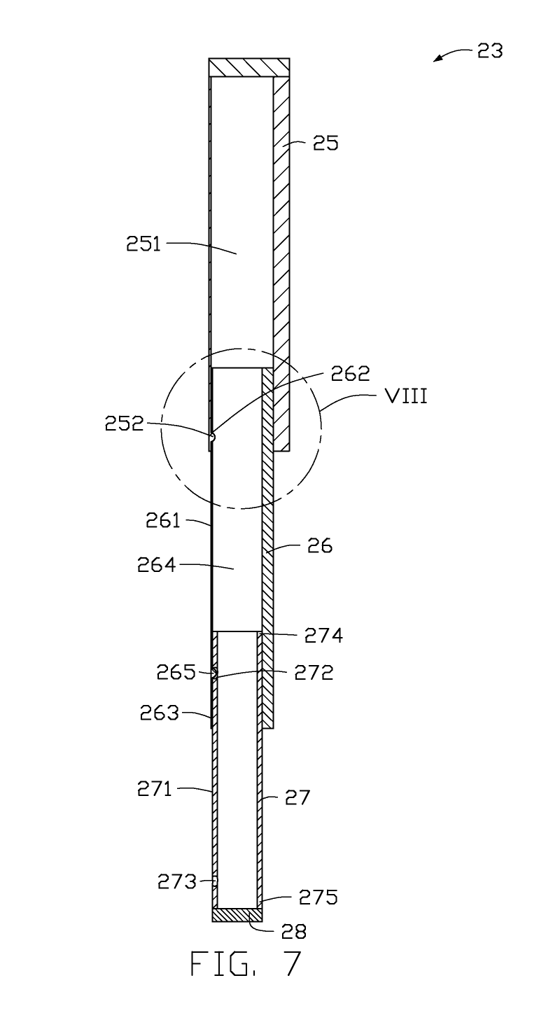

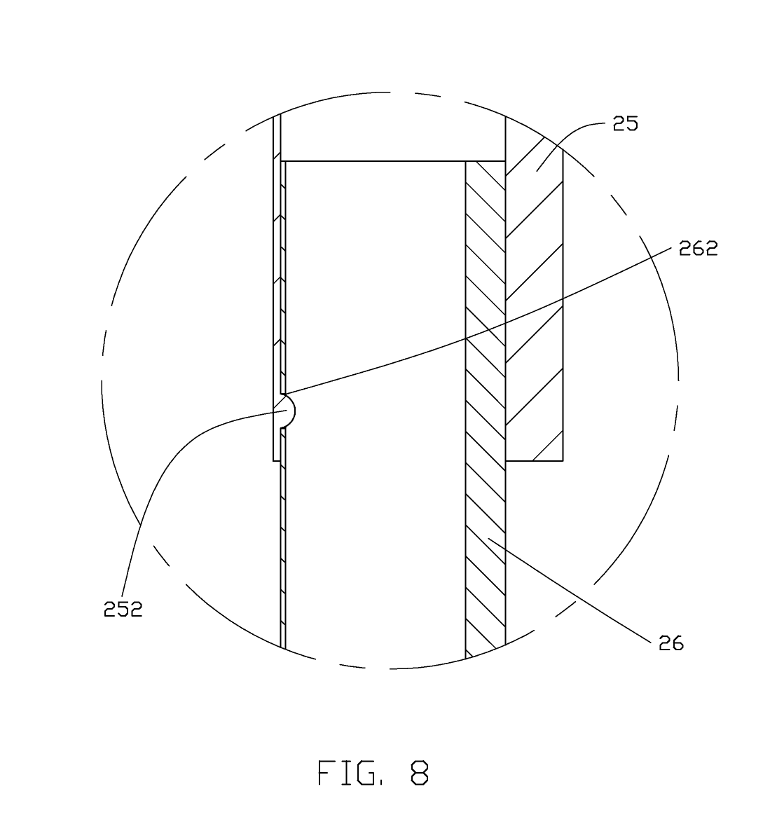

In at least one embodiment, each supporting rod 23 can include a first rod 25 and a second rod 26. Each first rod 25 can define a first hollow portion 251. Each first rod 25 can include a first resisting member 252. Each first resisting member 252 can be made of elastic material. Each first resisting member 252 can be fixed in a corresponding first hollow portion 251. Each second rod 26 can be movably received in the first hollow portion 251 of a corresponding first rod 25. A sidewall 261 of each second rod 26 can define two grooves, respectively a first groove 262 and a second groove 263. Each first groove 262 can be spaced from a corresponding second groove 263 by a first predetermined distance. Each first groove 262 can be configured to receive a corresponding first resisting member 252, and each second groove 263 can be configured to receive the corresponding first resisting member 252. Each first resisting member 252 can be slid to be received in the corresponding first groove 262 or to be received in the corresponding second groove 263, whereby the length of a corresponding supporting arm 20 can be adjusted (see FIGS. 7-8). The groove defined at the sidewall 261 of each second rod 26 can be any other number which is greater than one, such as three, four, or the like. The grooves defined at the sidewall 261 of each second rod 26 can be spaced from each other by the first predetermined distance. Each first resisting member 252 can be slid from being received in one groove to be received in another groove, whereby the length of the corresponding supporting arm 20 is adjusted. In other embodiments, the distance between two adjacent grooves defined at the sidewall 261 of the each second rod 26 can be different.

In at least one embodiment, each second rod 26 can define a second hollow portion 264. Each second rod 26 can include a second resisting member 265. Each supporting rod 23 can further include a third rod 27. Each third rod 27 can be movably received in the second hollow portion 264 of a corresponding second rod 26. A sidewall 271 of each third rod 27 can define two grooves, respectively a third groove 272 and a fourth groove 273. Each third groove 272 can be spaced from a corresponding fourth groove 273 by a second predetermined distance. Each third groove 272 can be configured to receive a corresponding second resisting member 265, and each fourth groove 273 can be configured to receive the corresponding second resisting member 265. Each second resisting member 265 can be slid to be received in a corresponding third groove 272 or to be received in a corresponding fourth groove 273, whereby the length of the corresponding supporting arm 20 can be further adjusted (see FIGS. 7-8). The groove defined at the sidewall 271 of each third rod 27 can be any other number which is greater than one, such as three, four, or the like. The distance between two adjacent grooves defined at the sidewall 271 of each third rod 27 can be same, or different. Each supporting rod 23 can further include other rods, such as a fourth rod, a fifth rod, or the like.

In at least one embodiment, each supporting arm 20 can further include an anti-slip member 28. Each third rod 27 can include a first end 274 and a second end 275 opposite to the first end 274. The second end 275 of each third rod 27 can be away from the second rod 26 with respect to the first end 274 of a corresponding third rod 27. Each anti-slip member 28 can be fixed at the second end 275 of the corresponding third rod 27. Each anti-slip member 28 can be configured to increase a friction between the corresponding supporting arm 20 and the surface 3.

In at least one embodiment, the lamps 30 can be fixed at the second surface 13 of the main body 10 and surround the slot 14. The lamps 30 can be configured to emit light for photography, causing the image captured by the camera 210 of the electronic device 2 to be clear. Each lamp 30 can be a white light-emitting diode.

To support the electronic device 2 while capturing images, each supporting arm 20 can form the first predetermined angle with the main body 10 and be positioned at the first predetermined angle, for example, each supporting arm 20 can form an angle of 90 degrees with the main body 10 and can be positioned at the 90 degrees. The supporting arms 20 can be placed on the surface 3, and contact the surface 3 to form at least three supporting points 201, to solely support the main body 10 and the electronic device 2 above the surface 3. The lamps 30 can light up the surface 3. Here, the electronic device 2 can be employed to capture images via the camera 210.

To support the electronic device 2 for viewing, each supporting arm 20 can form the first predetermined angle with the main body 10 and be positioned at the first predetermined angle, such as one supporting arm 20 can form an angle of 45 degrees with the main body 10 and can be positioned at 45 degrees, and the other supporting arms 20 can form an angle of 0 degrees with the main body 10 and can be positioned at 0 degrees. The supporting arms 20 can be placed on the surface 3, causing one edge 16 of the main body 10 to contact the surface 3. The supporting arms 20 and the edge 16 of the main body 10 can cooperatively prop up the electronic device 2 in a landscape orientation or in a portrait orientation for easy viewing. In at least one embodiment, the edge 16 of the main body 10 can be a left edge of the main body 10, a right edge of the main body 10, an upper edge of the main body 10, or a lower edge of the main body 10 because of the different angles formed between the supporting arms 20 and the main body 10.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A support device comprising:
a main body configured to support an electronic device and defining a slot being configured to allow light to pass through when a camera of the electronic device capture an image; and
at least two supporting arms coupled to the main body, the at least two supporting arms being configured to form a first predetermined angle with the main body and be positioned at the first predetermined angle, the at least two supporting arms being configured to contact a surface to form at least three supporting points when the at least two supporting arms are arranged on the surface, solely supporting the main body and the electronic device above the surface;
wherein the at least three supporting points on the surface are distributed in a shape of a surface.

2. The support device as described in claim 1, wherein:
each of the supporting arms comprises a supporting rod.

3. The support device as described in claim 2, wherein:
each of the supporting rods comprises a first rod and a second rod; each of the first rods defines a first hollow portion and comprises a first resisting member, the first resisting member is fixed in a corresponding first hollow portion;
each of the second rods is movably received in the first hollow portion of a corresponding first rod, a sidewall of each of the second rods defines a first groove and a second groove, each of the first grooves is spaced from a corresponding second groove by a first predetermined distance, each of the first grooves is configured to receive a corresponding first resisting member, each of the second grooves is configured to receive the corresponding first resisting member; and
each of the first resisting members is slid to be received in the corresponding first groove or to be received in the corresponding second groove, to adjust a length of a corresponding supporting arm.

4. The support device as described in claim 3, wherein each of the first resisting members is made of elastic material.

5. The support device as described in claim 3, wherein:
each of the second rods defines a second hollow portion and comprises a second resisting member;
each of the supporting rods further comprises a third rod, each of the third rods is movably received in the second hollow portion of a corresponding second rod, a sidewall of each of the third rods defines a third groove and a fourth groove, each of the third grooves is spaced from a corresponding fourth groove by a second predetermined distance, each of the third grooves is configured to receive a corresponding second resisting member, each of the fourth grooves is configured to receive the corresponding second resisting member; and
each of the second resisting members is slid to be received in a corresponding third groove or to be received in a corresponding fourth groove, to further adjust the length of the corresponding supporting arm.

6. The support device as described in claim 1, wherein:
each of the supporting arms comprises a connecting rod and at least two supporting rods;
each of the connecting rods comprises a first end and a second end opposite to the first end, the first end of each of the connecting rods is coupled to the main body, the second end of each of the connecting rods is coupled to a corresponding at least two supporting rods; and
each of the supporting rods forms a second predetermined angle with the corresponding connecting rod and is positioned at the second predetermined angle.

7. The support device as described in claim 6, wherein:
each of the supporting rods comprises a first rod and a second rod;
each of the first rods defines a first hollow portion and comprises a first resisting member, the first resisting member is fixed in a corresponding first hollow portion;
each of the second rods is movably received in the first hollow portion of a corresponding first rod, a sidewall of each of the second rods defines a first groove and a second groove, each of the first grooves is spaced from a corresponding second groove by a first predetermined distance, each of the first grooves is configured to receive a corresponding first resisting member, each of the second grooves is configured to receive the corresponding first resisting member; and
each of the first resisting members is slid to be received in the corresponding first groove or to be received in the corresponding second groove, to adjust a length of a corresponding supporting arm.

8. The support device as described in claim 7, wherein each of the first resisting members is made of elastic material.

9. The support device as described in claim 7, wherein:
each of the second rods defines a second hollow portion and comprises a second resisting member;
each of the supporting rods further comprises a third rod, each of the third rods is movably received in the second hollow portion of a corresponding second rod, a sidewall of each of the third rods defines a third groove and a fourth groove, each of the third grooves is spaced from a corresponding fourth groove by a second predetermined distance, each of the third grooves is configured to receive a corresponding second resisting member, each of the fourth grooves is configured to receive the corresponding second resisting member; and
each of the second resisting members is slid to be received in a corresponding third groove or to be received in a corresponding fourth groove, to further adjust the length of the corresponding supporting arm.

10. The support device as described in claim 1, wherein:
the supporting arms comprises one or more first supporting arms and one or more second supporting arms;
each of the first supporting arms comprises a supporting rod; and
each of the second supporting arms comprises a connecting rod and at least two supporting rods, each of the connecting rods comprises a first end and a second end opposite to the first end, the first end of each of the connecting rods is coupled to the main body, the second end of each of the connecting rods is coupled to a corresponding at least two supporting rods, each of the supporting rods forms a second predetermined angle with a corresponding connecting rod and is positioned at the second predetermined angle.

11. The support device as described in claim 10, wherein:
each of the supporting rods comprises a first rod and a second rod;
each of the first rods defines a first hollow portion and comprises a first resisting member, the first resisting member is fixed in a corresponding first hollow portion;
each of the second rods is movably received in the first hollow portion of a corresponding first rod, a sidewall of each of the second rods defines a first groove and a second groove, each of the first grooves is spaced from a corresponding second groove by a first predetermined distance, each of the first grooves is configured to receive a corresponding first resisting member, each of the second grooves is configured to receive the corresponding first resisting member; and
each of the first resisting members is slid to be received in the corresponding first groove or to be received in the corresponding second groove, to adjust a length of a corresponding supporting arm.

12. The support device as described in claim 11, wherein each of the first resisting members is made of elastic material.

13. The support device as described in claim 11, wherein:
each of the second rods defines a second hollow portion and comprises a second resisting member;
each of the supporting rods further comprises a third rod, each of the third rods is movably received in the second hollow portion of a corresponding second rod, a sidewall of each of the third rods defines a third groove and a fourth groove, each of the third grooves is spaced from a corresponding fourth groove by a second predetermined distance, each of the third grooves is configured to receive a corresponding second resisting member, each of the fourth grooves is configured to receive the corresponding second resisting member; and
each of the second resisting members is slid to be received in a corresponding third groove or to be received in a corresponding fourth groove, to further adjust the length of the corresponding supporting arm.

14. The support device as described in claim 1, wherein:
each of the supporting arms comprises an anti-slip member, each of the anti-slip members is fixed at the end of a corresponding supporting arm relatively away from the main body, each of the anti-slip members is configured to increase a friction between the corresponding supporting arm and the surface.

15. The support device as described in claim 1, wherein:
the main body comprises a first surface and a second surface opposite to the first surface, the main body defines a receiving groove extending from the first surface to the second surface, the receiving groove is configured to receive the electronic device, the supporting arms are coupled to the second surface of the main body.

16. The support device as described in claim 15, further comprising a plurality of lamps, wherein:
the lamps are fixed to the second surface of the main body and surround the slot, the lamps are configured to emit light for photography, causing the image captured by the camera of the electronic device to be clear.

17. The support device as described in claim 16, wherein:
each of the lamps is a white light-emitting diode.
